(19) United States
(12) Patent Application Publication
(10) Pub. No.: US 2013/0148113 A1
(43) Pub. Date: Jun. 13, 2013

(54) INSPECTION APPARATUS AND INSPECTION METHOD

(71) Applicants: Mizuki Oku, Hitachinaka (JP); Minori Noguchi, Joso (JP); Hiroshi Kawaguchi, Hitachinaka (JP); Kazuo Takahashi, Ninomiya (JP); Kei Shimura, Mito (JP)

(72) Inventors: Mizuki Oku, Hitachinaka (JP); Minori Noguchi, Joso (JP); Hiroshi Kawaguchi, Hitachinaka (JP); Kazuo Takahashi, Ninomiya (JP); Kei Shimura, Mito (JP)

(73) Assignee: HITACHI HIGH-TECHNOLOGIES CORPORATION, Minato-ku, Tokyo (JP)

(21) Appl. No.: 13/579,965

(22) PCT Filed: Dec. 20, 2010
(86) PCT No.: PCT/JP2010/007351

§ 371 Date: Sep. 20, 2012

(30) Foreign Application Priority Data
Mar. 31, 2010 (JP) 2010-080065
Aug. 23, 2010 (JP) 2010-185712

(51) Int. Cl. G01N 21/88

(52) U.S. Cl. CPC G01N 21/88
USPC 356/237.2

(57) ABSTRACT

The light scattered from the sample surface and foreign matter is imaged on an image intensifier and detected by a lens-coupled multi-pixel sensor such as a TDI sensor or a CCD sensor. The light scattered by surface roughness is spatially eliminated to detect the light scattered from foreign matter with increased sensitivity. A mechanism for shifting the image intensifier is incorporated to prevent a signal intensity decrease, which may be caused by a decrease in the sensitivity of the image intensifier.

### TECHNICAL FIELD

The present invention relates to an apparatus and method for inspecting a substrate.

For example, the present invention relates to a surface inspection apparatus for detecting semiconductor wafer defects such as tiny foreign matter and scratches.

### BACKGROUND ART

In a production line, for instance, for a semiconductor substrate or a thin-film substrate, defects on the surface, for instance, of the semiconductor substrate or the thin-film substrate are checked for in order to maintain or improve the yield rate of production.

A conventional technology for a surface inspection apparatus is disclosed, for instance, in Patent Document 1. This conventional technology irradiates the surface of a sample with condensed illumination light to detect light scattered by surface roughness or surface defects.

An inspection apparatus that uses an LED as a light source is disclosed, for instance, in Patent Documents 1 and 2.

A technology related to an optical fiber is disclosed, for instance, in Patent Document 4.

Another conventional technology for the surface inspection apparatus is disclosed, for instance, in Patent Document 5.

### PRIOR ART LITERATURE

### Patent Documents

Patent Document 1: JP-2005-3447-A
Patent Document 2: JP-2008-153655-A
Patent Document 3: JP-2008-277596-A
Patent Document 4: U.S. Pat. No. 7,627,007
Patent Document 5: U.S. Pat. No. 7,548,308

### SUMMARY OF THE INVENTION

### Problems to be Solved by the Invention

However, the LED is a surface-emitting device. Therefore, it is difficult for the LED to produce condensed light in a tiny region unlike a laser light source. Further, the LED has a complicated shape and a complex light intensity distribution.

Hence, the LED cannot readily provide thin-line illumination when used for testing purposes, and suffers from increased noise due to the surface roughness of a sample. Further, although the signal intensity of the LED needs to be calibrated in accordance with the complex light intensity distribution, such calibration is very difficult to achieve in some cases. However, these disadvantages have not been taken into consideration.

### Means for Solving the Problems

The present invention contains the following features.

The present invention contains the following features, which may be configured independently or in combination with other features of the present invention.

It is a first feature of the present invention to include an LED light source (e.g., a light-emitting device based on electroluminescence), allow light emitted from the LED light source to be incident on the surface of a sample through an optical fiber, image scattered light on a plurality of image sensors, and spatially remove the influence of surface roughness to detect light scattered from a defect with increased sensitivity compared with the conventional technologies.

It is a second feature of the present invention to image the scattered light on an image intensifier, include a lens-coupled multi-pixel sensor such as a TDI sensor or a CCD sensor, and shift the image intensifier to prevent a signal intensity decrease, which may be caused by a decrease in the sensitivity of the image intensifier.

It is a third feature of the present invention to include at least one LED light source and a waveguide that guides the light emitted from the LED light source.

It is a fourth feature of the present invention that the above-described radiation optical system includes an optical device, which is disposed between the LED light source and the waveguide to diffuse the light emitted from the LED light source.

It is a fifth feature of the present invention that the waveguide is an optical fiber or an iris.

It is a sixth feature of the present invention that the waveguide is a single-core optical fiber.

It is a seventh feature of the present invention that the waveguide is a multi-core optical fiber.

It is an eighth feature of the present invention that cores are linearly disposed at a substrate side end of the multi-core optical fiber.

It is a ninth feature of the present invention to include a first LED light source having a first wavelength and a second LED light source having a second wavelength.

It is a tenth feature of the present invention that the radiation optical system includes a reflection optical system.

It is an eleventh feature of the present invention to include a first multi-core optical fiber, which guides first light from the first LED light source, and a second multi-core optical fiber, which guides second light from the second LED light source. Cores of the first multi-core optical fiber and cores of the second multi-core optical fiber are alternately disposed at the substrate side end.

It is a twelfth feature of the present invention that the cores of the first multi-core optical fiber and the cores of the second multi-core optical fiber, which guides the second light from the second LED light source, are randomly disposed at the substrate side end.

It is a thirteenth feature of the present invention to include a cylindrical lens that condenses light transmitted through the waveguide.

It is a fourteenth feature of the present invention to include an optical device that adjusts the polarization of light transmitted through the waveguide.

It is a fifteenth feature of the present invention to include a detection optical system that detects light from a substrate. The detection optical system is an imaging optical system and provided with a sensor having a plurality of pixels.

It is a sixteenth feature of the present invention to include an amplification device that amplifies the light from the substrate. The sensor detects the light amplified by the amplification device.

It is a seventeenth feature of the present invention to include a transfer unit that transfers the amplification device.

It is an eighteenth feature of the present invention to include an optical device that provides spatial division between the sensor and the amplification device.

It is a nineteenth feature of the present invention to provide a substrate testing method of averaging the light emitted from at least one LED light source and irradiating a substrate with the averaged light.

It is a twentieth feature of the present invention to linearly condense the averaged light and irradiate the substrate with the condensed light.

It is a twenty-first feature of the present invention to change a region on which the light emitted from the substrate is incident on the amplification device.

It is a twenty-second feature of the present invention to form an image by spatially dividing the amplified light.

### Advantages of the Invention

According to the present invention, the complex light intensity distribution of an LED light source can be solved to implement a inspection apparatus based on the LED light source. Consequently, the implemented inspection apparatus provides the following advantages. The following advantages may be provided individually or simultaneously.

(1) Long life.

### (2) Inexpensive.

(3) Increased space savings are provided because no space is required, for instance, for a power supply or a cooler except for the light source. This also reduces the amount of power consumption.
(4) LEDs can emit continuous light. Therefore, the LEDs are not likely to damage optical devices or the surface of a sample unlike a short-pulse laser with a high energy density.

### BRIEF DESCRIPTION OF THE DRAWINGS

FIG. 1 is a schematic diagram illustrating a surface inspection apparatus according to a first embodiment of the present invention.

FIGS. 2(a) and 2(b) are diagrams illustrating the positional relationship between an illumination spot and a detection optical system.

FIG. 3 is a schematic diagram illustrating the detection optical system based on a diffraction grating.

FIG. 4 is a schematic diagram illustrating a detection unit circuit.

FIGS. 5(a) and 5(b) are diagrams illustrating the size of an illumination spot and the intensity of a signal that are obtained when a conventional technology is used.

FIG. 6 is a diagram illustrating the intensity of a signal that is obtained when a multi-pixel optical sensor is used.

FIGS. 7(a) and 7(b) are schematic diagrams illustrating a detection system according to a second embodiment of the present invention.

FIGS. 8(a) to 8(d) are schematic diagrams illustrating an illumination system according to a third embodiment of the present invention.

FIGS. 9(a) to 9(c) are schematic diagrams illustrating the arrangement of cores of a multi-core optical fiber according to a fourth embodiment of the present invention.

FIGS. 10(a) and 10(b) are schematic diagrams illustrating the illumination system according to a fifth embodiment of the present invention.

FIGS. 11(a) and 11(b) are schematic diagrams illustrating the illumination system according to a sixth embodiment of the present invention.

FIG. 12 is a schematic diagram illustrating the surface inspection apparatus according to a seventh embodiment of the present invention.

FIGS. 13(a) to 13(c) are enlarged views of a light amount adjustment unit according to the seventh embodiment of the present invention.

FIGS. 14(a) to 14(c) are schematic diagrams illustrating a light amount adjustment evaluation device according to the seventh embodiment of the present invention.

FIG. 15 is an enlarged view of a multiplexer according to the seventh embodiment of the present invention.

### MODE FOR CARRYING OUT THE INVENTION

Embodiments of the present invention will now be described with reference to the accompanying drawings.

### First Embodiment

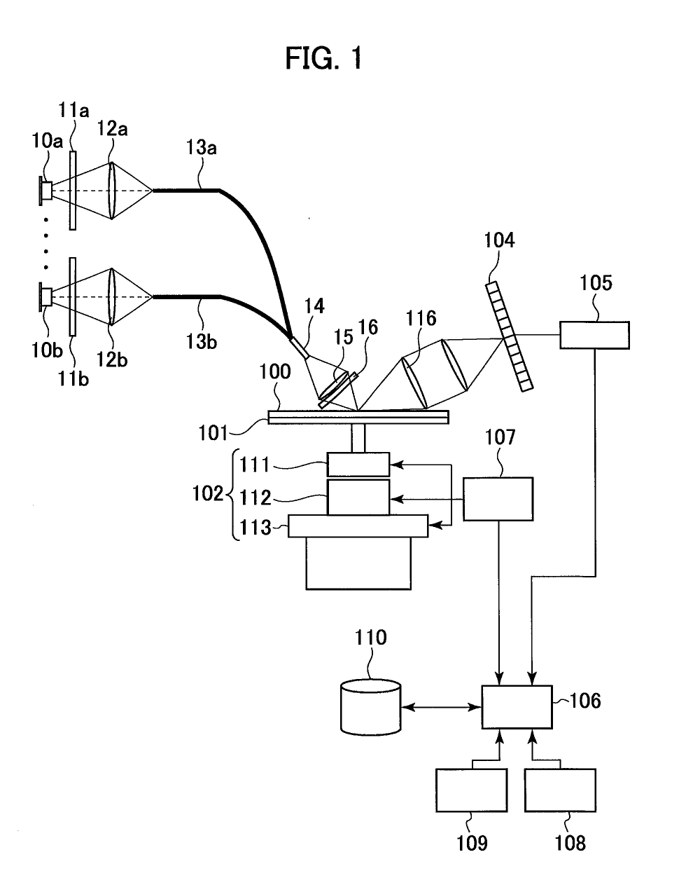

FIG. 1 is a schematic diagram illustrating a surface inspection apparatus according to a first embodiment of the present invention.

As shown in FIG. 1, the surface inspection apparatus includes, for example, illumination LED light sources 10a, 10b, diffuser plates 11a, 11b, lenses 12a, 12b, optical fibers 13a, 13b, a sample stage 101, a stage drive unit 102, a multi-pixel sensor 104 for detecting scattered light, a signal processing unit 105, an overall control unit 106 for performing later-described various control functions, a mechanical control unit 107, an information display unit 108, an input operation unit 109, and a storage unit 110.

The stage drive unit 102 includes a rotary drive unit 111 for rotating the sample stage 101 around a rotation axis, a vertical drive unit 112 for moving the sample stage 101 in a vertical direction, and a slide drive unit 113 for moving the sample stage 101 in the radial direction of a sample.

Light emitted from the illumination LED light sources 10a, 10b is shed on the sample 100 by using the optical fibers 13a, 13b, which constitute an example of a waveguide. Light scattered, diffracted, or reflected from foreign matter and defects on the sample surface or in the vicinity of the sample surface and light scattered, diffracted, or reflected from the surface of the sample are then captured by a detection optical system 116 and imaged on the multi-pixel sensor 104.

The sample stage 101 supports the sample 100 such as a wafer. When the sample stage 101 is moved in a horizontal direction by the slide drive unit 113 while it is rotated by the rotary drive unit 111, illumination light relatively scans the surface of the sample 100 in a spiral pattern.

Consequently, the light scattered from surface irregularities of the sample is continuously generated, whereas the light scattered from defects is generated in a pulsed manner. Thus, shot noise of the continuously generated light becomes a noise component for the surface inspection apparatus.

In the present embodiment, it is assumed that the sample stage 101 acts as a rotary stage and as a translational stage. Alternatively, however, a two-axis translational stage may be used.

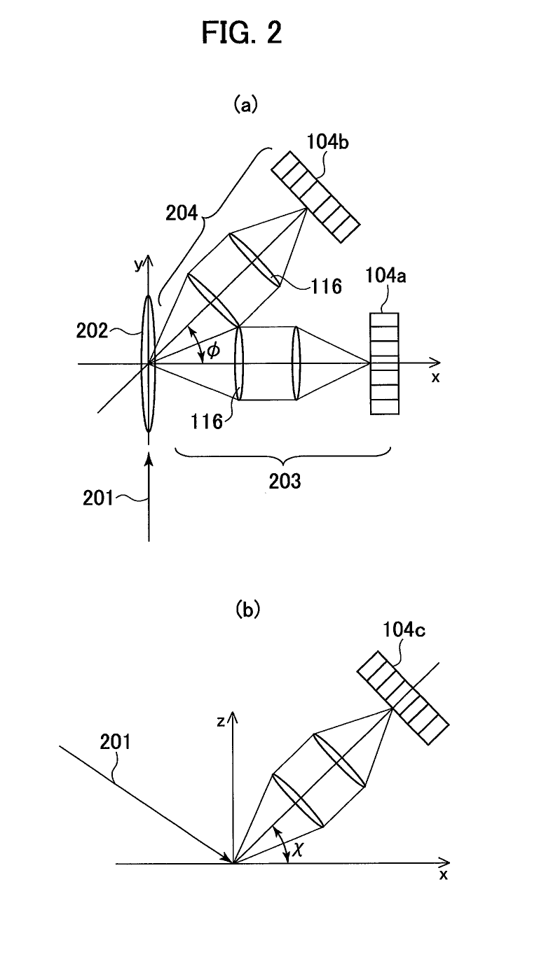

FIGS. 2(a) and 2(b) are diagrams illustrating the positional relationship between an illumination spot and the detection optical system.

Although one multi-pixel sensor is shown in FIG. 1, the number of sensors is not limited as shown in FIGS. 2(a) and 2(b). Two or more sensors can be disposed in such a manner that they differ in at least either the azimuth angle θ or elevation angle χ from illumination light 202.

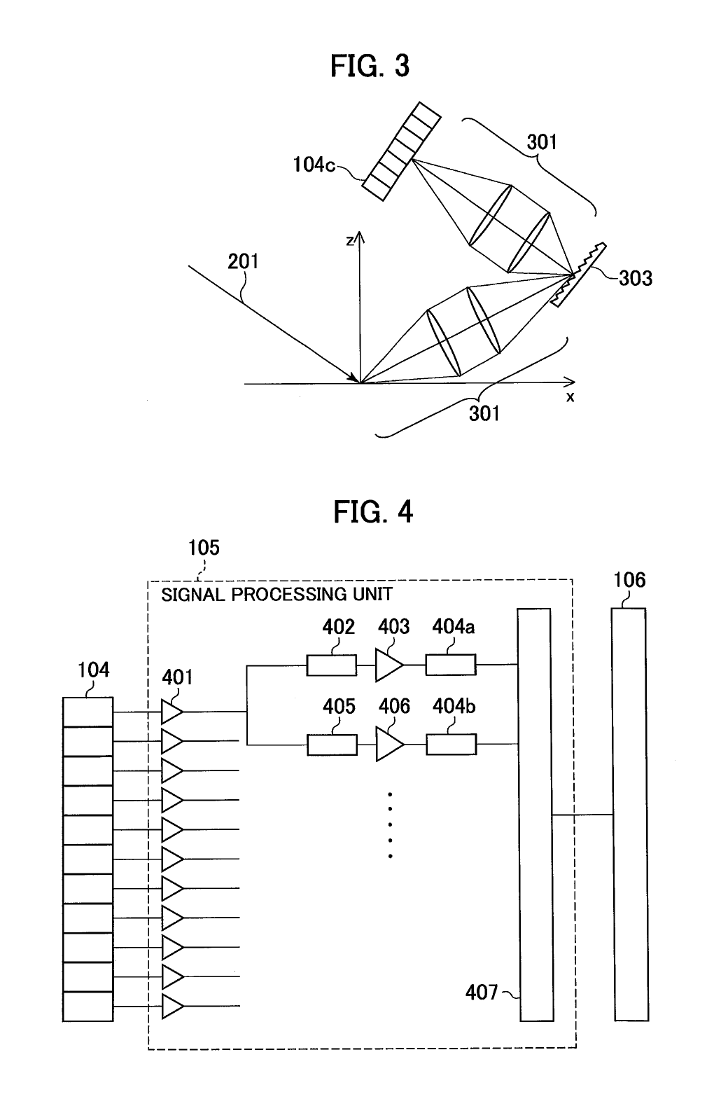

Further, the detection optical system may use a linear imaging system shown in FIG. 1 or form a first real image of scattered light on a diffraction grating 303 with an imaging optical system 301 and form an enlarged image on a multi-pixel sensor 104c with a second imaging optical system 302 as shown in FIG. 3.

FIG. 4 is a schematic diagram illustrating a detection unit circuit.

The scattered light generated is detected by the multi-pixel sensor 104, passed through a BPF (band-pass filter 402) and an LPF (low-pass filter 405), which are included in the signal processing unit 105, and separated into a high-frequency component and a low-frequency component.

The resulting signals are corrected by amplifiers 403, 406 until they are equal in sensitivity to the other channels, converted to digital equivalents by analog-to-digital converters 404a, 404b, and stored in a storage unit 407 of a computer. If sensitivity varies from one sensor to another, an amplifier 401 may be used to make signal intensity corrections.

Using an LED in place of a laser in the surface inspection apparatus provides, for instance, the following advantages.

The following advantages may be provided individually or simultaneously.

(1) The light source for the surface inspection apparatus lasts long.
(2) Space requirements for the surface inspection apparatus are reduced because the light source is small in size and no space is required, for instance, for a power supply and a cooler.
(3) The surface inspection apparatus can be configured to reduce the amount of power consumption.
(4) The surface inspection apparatus can be configured to deliver high performance at low cost because there is no need to use a power supply or a cooler.
(5) As the LED can emit continuous light, the surface inspection apparatus is less likely to damage the surface of the sample than a short-pulse laser with a high energy density.

When the LED is used, it is difficult to provide thin-line illumination because the LED is a surface-emitting device. In addition, the LED has a complicated shape and a complex light intensity distribution.

For testing applications, signal intensity calibration needs to be achieved in accordance with a thin-line illumination optical system and its complex light intensity distribution. In some cases, however, such calibration is extremely difficult to achieve.

As shown in FIG. 1, the light emitted from the illumination LED light sources 10a, 10b is diffused by the diffuser plates 11a, 11b in order to average the LED's complex light intensity distribution.

Further, the lenses 12a, 12b are used to guide the light into the single-core optical fibers 13a, 13b.

The optical fibers 13a, 13b may alternatively be multi-mode optical fibers.

As the multi-mode optical fibers have a large core diameter, they are at an advantage in that they can reduce the light loss at a fiber end face even during the use of LED light, which cannot be condensed to a spot.

As the light is reflected a number of times within an optical fiber, its intensity is further averaged to ease, for instance, a peculiar light intensity peak.

A condensing lens 15 is disposed at a trailing end of the optical fiber to condense the light on the surface of the sample for irradiation purposes. A cylindrical lens may be used as the condensing lens 15 to provide linear illumination.

The light may be allowed to pass through a polarizer 16 to provide uniform polarization. The polarizer 16 can be rotated to adjust the direction of polarization.

The light intensity distribution on the sample surface may be measured in advance to standardize a signal in accordance with the measured light intensity distribution.

LED light is lower in intensity than laser light. Therefore, two or more LEDs may be disposed as shown in FIG. 1 so that their light beams are directed by optical fibers and coupled by a coupler 14 to obtain adequate scattered light intensity.

A plurality of LEDs having different wavelengths may be used as well. In such an instance, the optical path subsequent to the optical fibers should be formed by a reflection optical system based on a parabolic mirror instead of a transmission detection optical system based, for instance, on the condensing lens 15.

Using the reflection optical system makes it possible to avert the influence of chromatic aberration. The use of different wavelengths makes it possible to efficiently detect wavelength-dependent defects.

### Second Embodiment

A second embodiment of the present invention will now be described.

Another disadvantage associated with the use of an LED is that the LED cannot provide spot irradiation on the sample surface because it is a surface-emitting diode. Therefore, the image formed by the LED is of a certain size according to the Helmholtz-Lagrange invariant.

Consequently, a large amount of scattered light is generated by surface roughness, which results in noise. Hence, light scattered from tiny defects cannot readily be acquired.

In view of the above circumstances, the second embodiment uses an imaging detection optical system and a multi-pixel sensor to spatially eliminate a noise component for purposes of sensitivity enhancement.

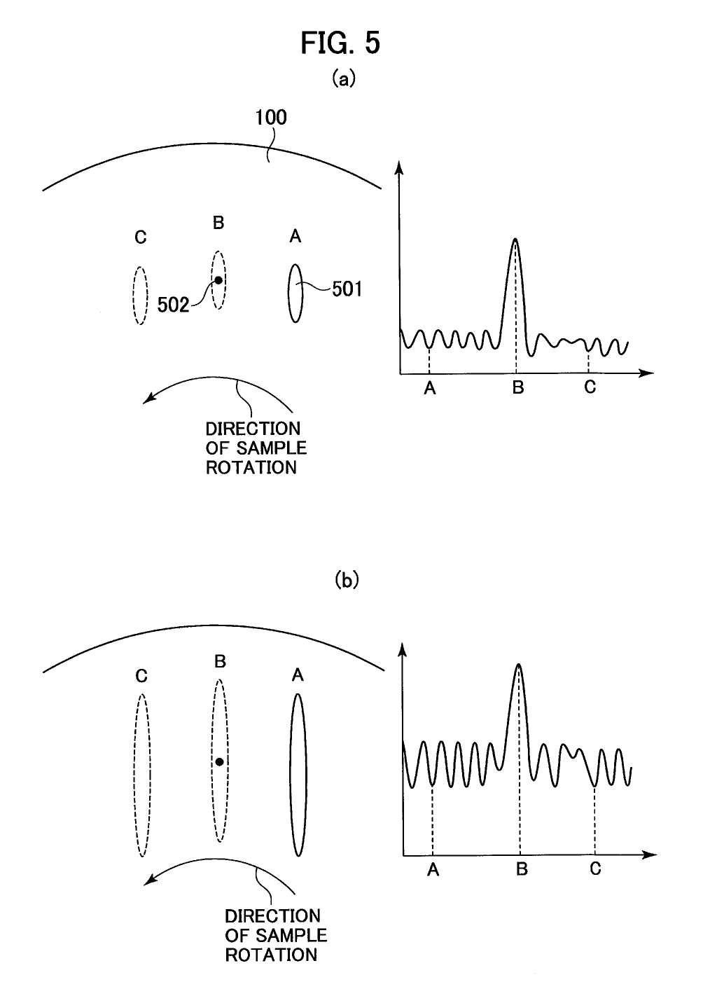

FIGS. 5(a) and 5(b) are diagrams illustrating a signal used in the second embodiment.

FIG. 5(a) shows illumination light 501 on the sample surface and a signal intensity that are obtained when a laser light source is used in a conventional manner.

When the illumination light 501 is incident on region A, only light scattered by surface roughness is detected.

The same holds true for region C.

In region B in which the illumination light is incident on a defect 502 during a rotation of the sample, light scattered from the defect is detected in a pulsed manner.

When a laser is used as an illumination light source, the light can be condensed in a tiny region. Therefore, a small amount of light is scattered by the surface roughness of the sample.

FIG. 5(b) shows a case where an LED is used as the light source.

Even when the light emitted from the trailing end of an optical fiber is condensed by a lens as shown in FIG. 1, the LED cannot condense the light to a spot within a tiny region unlike a laser.

Therefore, when the light is emitted from the LED at the same power density as when a laser light source is used, the intensity of light scattered by surface roughness is higher than when the laser light source is used, as indicated in FIG. 5(b), although the intensity of light scattered from a defect remains unchanged.

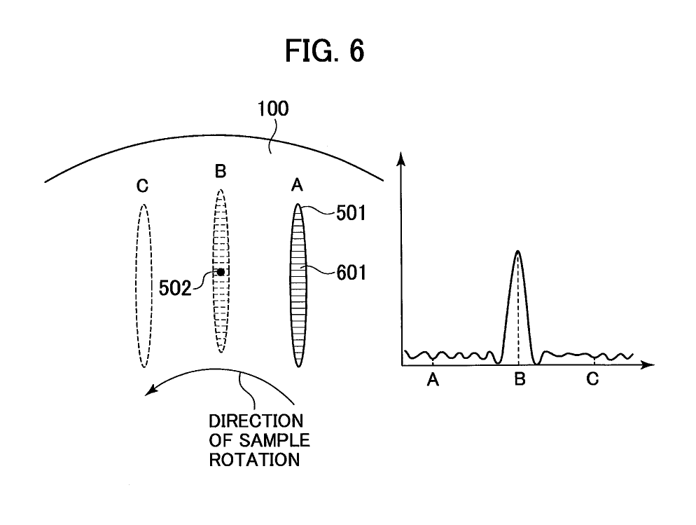

FIG. 6 is a diagram illustrating a signal intensity obtained when a multi-pixel optical sensor is used.

A primary method of detecting tiny foreign matter in the surface inspection apparatus is to increase the amount of light scattered from the foreign matter by increasing the amount of incident light, to increase the total amount of scattered light by increasing the length of testing time, or to reduce the noise component by using a multi-pixel sensor in accordance with the second embodiment.

An increase in the amount of incident light may damage the sample surface by raising its temperature.

In view of the above circumstances, the second embodiment uses a multi-pixel sensor in order to detect tiny foreign matter without changing the testing time.

As shown in FIG. 6, the use of the multi-pixel sensor makes it possible to make measurements while a detection region is spatially divided into a plurality of sectors. Therefore, the amount of light scattered from the surface irregularities of the sample can be decreased to permit the detection of smaller defects.

The required number of pixels can be calculated from the number of photons scattered by corresponding grains and the number of photons scattered by surface roughness.

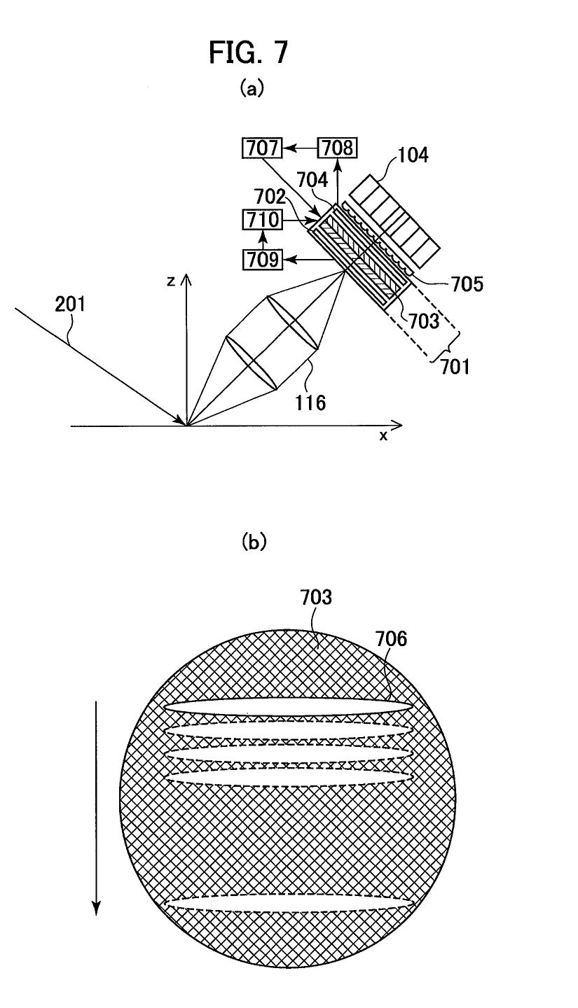

FIGS. 7(a) and 7(b) are schematic diagrams illustrating a detection system according to the second embodiment.

Light scattered from a defect is weak and therefore needs to be amplified by an intensifier tube such as an image intensifier 701.

In the image intensifier 701, electrons generated by photoelectric conversion are amplified by an MCP (multi-channel plate) 703 and made incident on a fluorescent plate 704 to acquire visible light.

The above-mentioned image intensifier components are retained in vacuum. However, when electrons are incident on the MCP on which a trace amount of extraneous chemical substance is deposited, the MCP becomes damaged to decrease an amplification factor.

As such being the case, when a predetermined period of time has elapsed or when the amplification factor is decreased, a horizontal drive unit 707, which is an example of a transfer unit, shifts the position of the image intensifier 701 to detect and amplify the light with use of a new location on the image intensifier as shown in FIG. 7(b).

For the above instance, a sensor 708 for measuring the shift amount of the image intensifier 701 may be added and used.

Using the sensor 708 makes it possible to effectively use a limited area of the image intensifier 701.

As the illumination light provides linear illumination, the scattered light forms a linear image on the image intensifier.

Even when the stage used for the horizontal drive unit exhibits inadequate planar positional accuracy, testing results will remain unaffected. However, inadequate angular accuracy causes distortion on the multi-pixel sensor. Therefore, due care needs to be exercised to maintain adequate angular accuracy.

As such being the case, a sensor 709 for measuring the angle of the image intensifier and an angle adjustment mechanism 710 for adjusting the angle in accordance with the angle measured by the sensor 709 may be added and used.

In the above instance, the image intensifier can be shifted while suppressing the distortion on the multi-pixel sensor.

For ease of shifting, lens coupling is provided, instead of optical fiber coupling, between the image intensifier 701 and the multi-pixel sensor 104 by using a micro-array lens 705 or the like with a space provided (in a divided manner).

The second embodiment has been described on the assumption that an image pick-up system formed by a combination of the image intensifier 701 and a CCD or TDI camera is used as the multi-pixel sensor 104. Alternatively, however, a multi-anode photomultiplier tube, an avalanche photodiode array, a CCD linear sensor, an EM-CCD (electron multiplying CCD), or an EB-CCD (electron bombardment CCD) may also be used.

### Third Embodiment

A third embodiment of the present invention will now be described. Mainly the differences from the first and second embodiments are described below.

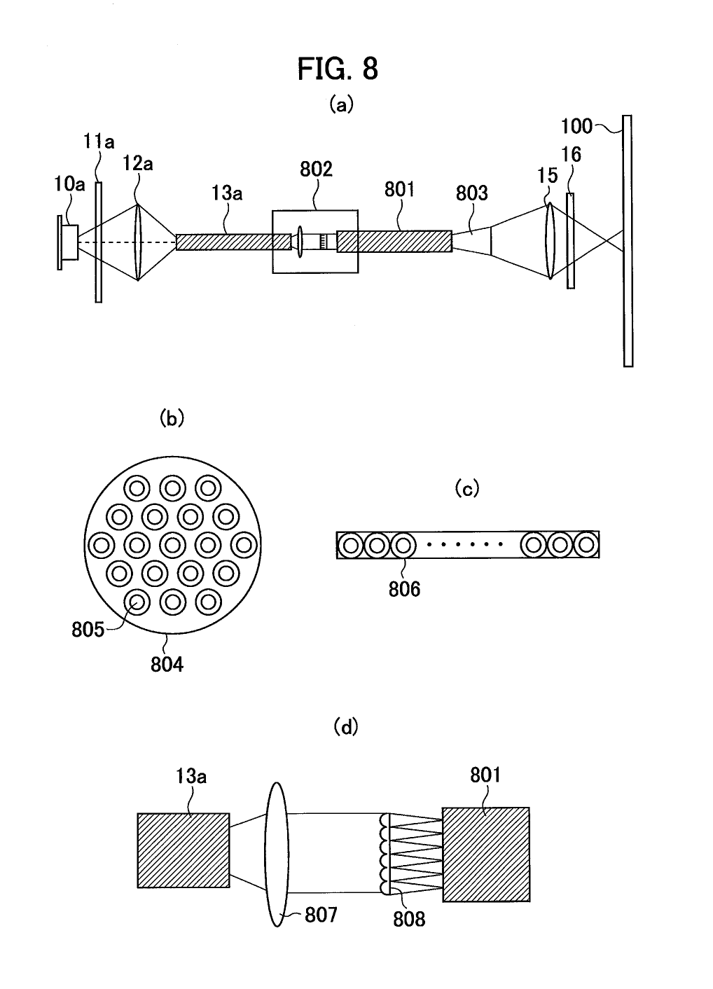

FIGS. 8(a) to 8(c) are schematic diagrams illustrating an illumination system according to the third embodiment.

As shown in FIG. 8(a), a multi-core optical fiber is used to provide thin-line illumination.

First of all, light emitted from the LED light source 10a is guided into the single-core optical fiber 13a through the lens 12a to provide uniform light intensity.

FIG. 8(c) is an enlarged view of a coupling portion shown in FIG. 8(a).

As shown in FIG. 8(c), the light uniformed as it passes through the single-core optical fiber 13a is rendered parallel by a parallel light lens 807 and guided into a multi-core optical fiber 801 through a micro lens 808 to avoid light loss.

A focal position at which the parallel light is condensed by the micro lens 808 is located on an end face of the multi-core optical fiber 801.

At an optical fiber trailing end 803, cores 805 disposed as shown in FIG. 8(b) are arranged in a ribbon-like form (that is, in a linear or stripe form) as shown in FIG. 8(c).

The light is linearly emitted and then condensed on the sample surface by the condensing lens 15.

However, image formation occurs to represent the shapes of the cores. Hence, the light is blurred and made incident on the sample surface as shown in FIG. 8(a) in order to reduce brightness irregularities.

In the above instance, a cylindrical lens may be used as the condensing lens 15.

Further, a diffuser plate may be disposed between the multi-core optical fiber and the sample surface to reduce brightness irregularities.

### Fourth Embodiment

A fourth embodiment of the present invention will now be described.

Mainly the differences between the fourth embodiment and the other embodiments are described below.

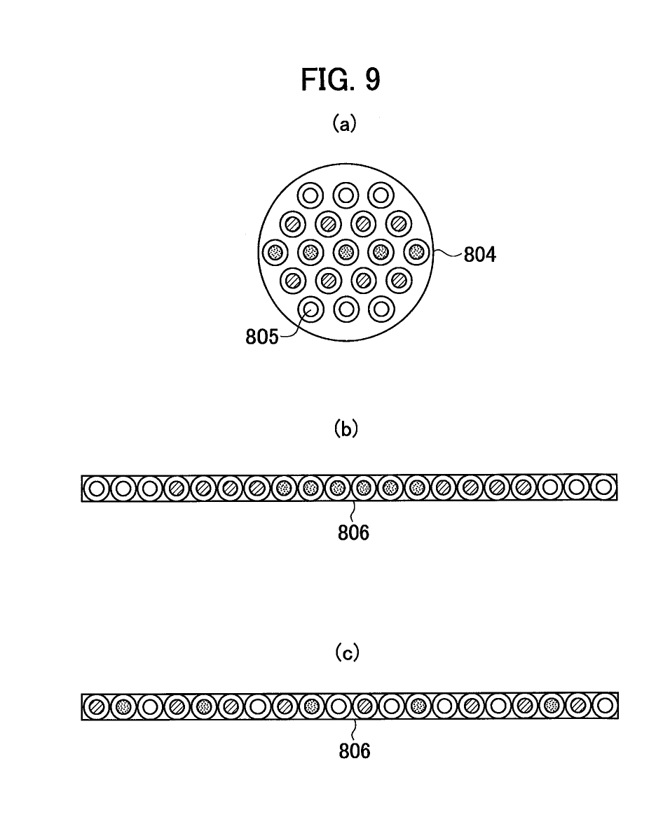

FIGS. 9(a) to 9(c) are schematic diagrams illustrating the arrangement of cores of a multi-core optical fiber according to the fourth embodiment.

The cores may be disposed as shown in FIGS. 9(a) and 9(b) so that the central core of the leading end of an optical fiber is positioned at the center of the trailing end of the optical fiber while the outer cores are orderly positioned around the central core. Alternatively, the cores may be randomly arranged without regard to the core arrangement at the leading end of the optical fiber.

### Fifth Embodiment

A fifth embodiment of the present invention will now be described.

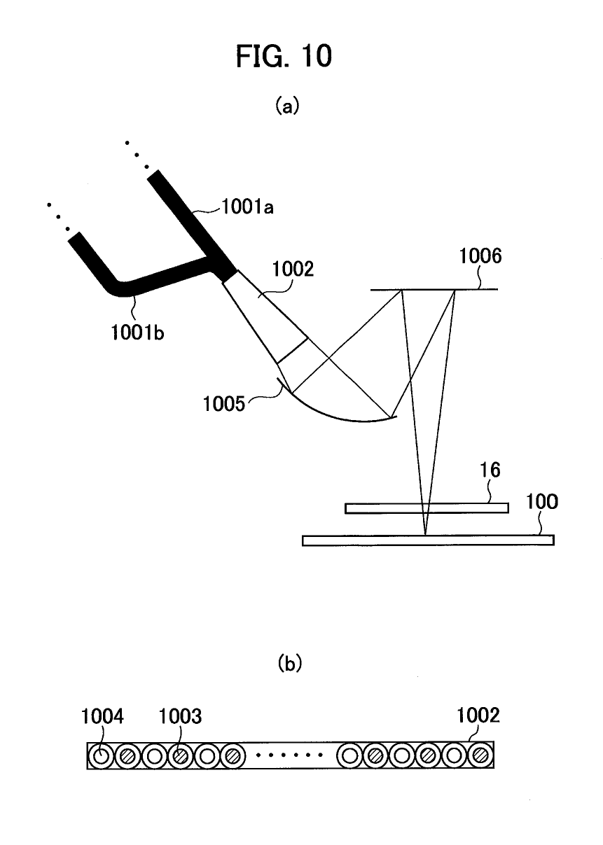

FIGS. 10(a) and 10(b) are schematic diagrams illustrating the illumination system according to the fifth embodiment.

In the radiation optical system according to the fifth embodiment, two multi-core optical fibers 1001a, 1001b for guiding the light from an LED light source having different wavelengths are connected. The cores of the multi-core optical fibers 1001a, 1001b are alternately disposed as shown in FIG. 10(b) at an optical fiber trailing end 1002, which connects the two multi-core optical fibers 1001a, 1001b.

The light is then reflected by a total reflection optical system, which includes, for example, a concave mirror 1005 and a mirror 1006, and condensed on the sample 100 through the polarizer 16.

If thin-line illumination is to be provided by using a plurality of LEDs having different wavelengths and the multi-core optical fibers, coupling may be achieved at a single-core optical fiber portion or at a multi-core optical fiber portion.

When coupling is to be achieved at the single-core optical fiber portion, the coupler 14 is used for coupling purposes as shown in FIG. 1.

Further, as described earlier, the cores at the optical fiber trailing end may be orderly arranged from the center to the outer circumference.

The fifth embodiment can avert the influence of chromatic aberration. Further, the use of different wavelengths makes it possible to efficiently detect wavelength-dependent defects.

### Sixth Embodiment

A sixth embodiment of the present invention will now be described.

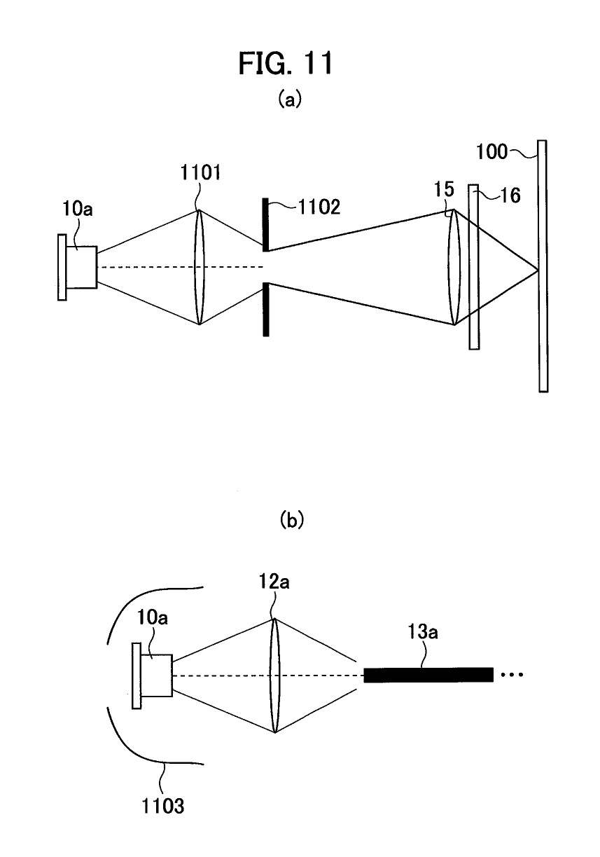

FIGS. 11(a) and 11(b) are schematic diagrams illustrating the illumination system according to the sixth embodiment.

When the light is extremely intense at the outer circumference of a light-emitting portion of the illumination LED light source 10a, a light selection iris 1102, which is another example of the waveguide, may be used in place of an optical fiber. The light selection iris 1102 may be placed behind a condensing lens 1101 as shown in FIG. 11(a) to acquire only a region having a desired light intensity distribution. The acquired light may be condensed by the condensing lens 15 and made incident on the sample surface through the polarizer 16.

Further, as shown in FIG. 11(b), a light condensing reflection mirror 1103 may be disposed around the rear and lateral surfaces of the illumination LED light source to efficiently acquire the light from the illumination LED light source. Furthermore, the optical fiber light condensing lens 12a in front of the illumination LED light source may be used to guide the light into the optical fiber 13a.

Even when the light is extremely intense at the outer circumference of the light-emitting portion of the illumination LED light source 10a, the sixth embodiment makes it possible to perform testing.

### Seventh Embodiment

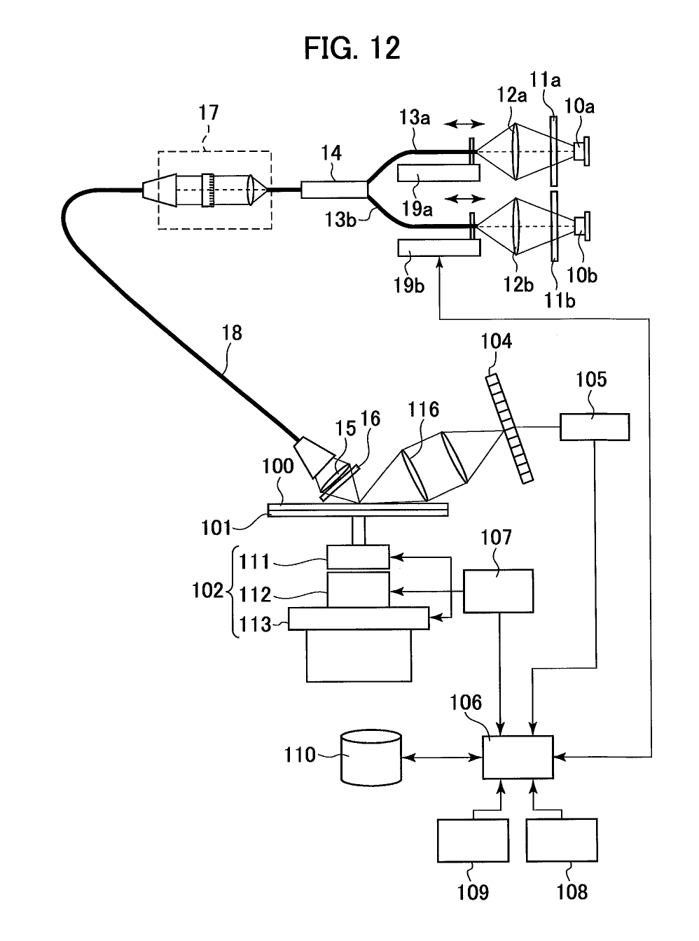

FIG. 12 is a schematic diagram illustrating the surface inspection apparatus according to a seventh embodiment of the present invention.

As shown in FIG. 12, the surface inspection apparatus includes, for example, illumination LED light sources 10a, 10b having the same intensity, diffuser plates 11a, 11b, lenses 12a, 12b, optical fibers 13a, 13b, light amount adjustment stages 19a, 19b, a multiplexer 14, a multi-core optical fiber coupler 17, a multi-core optical fiber 18, a sample stage 101, a stage drive unit 102, a multi-pixel sensor 104 for detecting scattered light, a signal processing unit 105, an overall control unit 106, a mechanical control unit 107, an information display unit 108, an input operation unit 109, and a storage unit 110.

The stage drive unit 102 includes a rotary drive unit 111 for rotating the sample stage 101 around a rotation axis, a vertical drive unit 112 for moving the sample stage 101 in a vertical direction, and a slide drive unit 113 for moving the sample stage 101 in the radial direction of the sample.

Light emitted from the illumination LED light sources 10a, 10b is directed into the optical fibers 13a, 13b, which constitute an example of a waveguide. A plurality of LED light beams are then coupled by the multiplexer 14 to provide increased brightness.

The emitted light is guided into the multi-core optical fiber 18 through the coupler 17.

The light is then shed on the sample 100 through the lens 15.

As the illumination light sources, highly directional high-brightness LD (laser diode) or SLD (super luminescent diode) light sources may be used in place of the LED light sources 10a, 10b.

The use of an LD or SLD provides increased light use efficiency. Therefore, even when the number of LD or SLD light sources is decreased, the same power density is obtained as when a LED light source is used over the sample 100. This advantage provides increased space savings.

The light scattered, diffracted, or reflected from foreign matter and defects on the sample surface or in the vicinity of the sample surface and the light scattered, diffracted, or reflected from the sample surface are captured by the detection optical system 116 and imaged on the multi-pixel sensor 104.

Although one multi-pixel sensor is shown in FIG. 12, the number of sensors is not limited. Further, a single-channel PMT or photodiode may be used in place of the multi-pixel sensor.

The sample stage 101 supports the sample 100 such as a wafer. When the sample stage 101 is moved in a horizontal direction by the slide drive unit 113 while it is rotated by the rotary drive unit 111, illumination light relatively scans the surface of the sample 100 in a spiral pattern.

When the rotation speed of the sample stage 101 remains constant, the length of irradiation time for the central portion of the sample 100 differs from that for the outer circumference of the sample 100.

If, for instance, incident power is increased to raise the signal-to-noise ratio at the outer circumference of the sample, the central portion of the sample, which is irradiated for a relatively long period of time, may raise its surface temperature and become damaged.

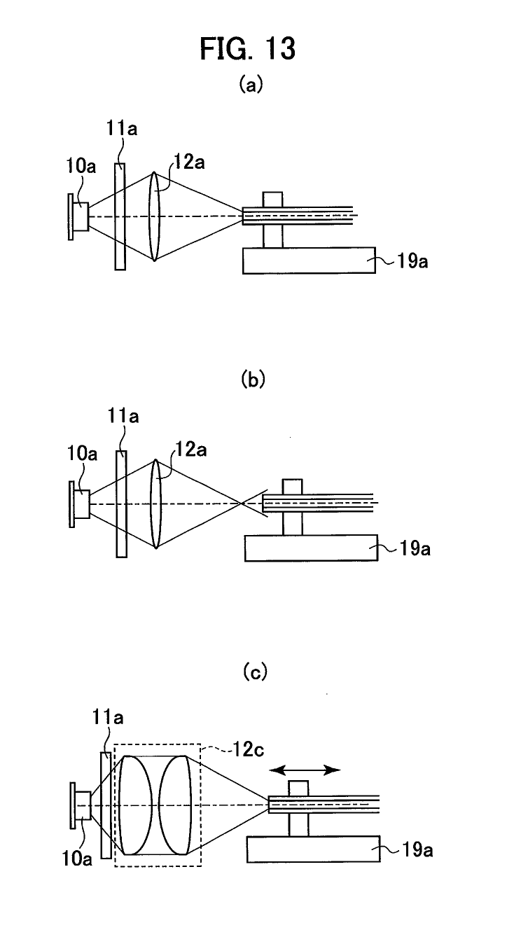

FIGS. 13(a) to 13(c) are schematic diagrams illustrating a light intensity adjustment mechanism for providing a uniform signal-to-noise ratio and preventing the sample from being damaged.

The light intensity adjustment stage 19a is used to vary the position of the incident end of an optical fiber relative to the focal position of the lens 12a, as shown in FIGS. 13(a) and 13(b), thereby adjusting the amount of light entering the optical fiber 13a.

In the above instance, which has been described with reference to FIGS. 13(a) and 13(b), the position of the optical fiber is changed. Alternatively, however, the positions of the condensing lens and of the light source may be changed simultaneously or independently for adjustment purposes.

For positional adjustment purposes, the light amount adjustment stage based on a piezoelectric element is preferably used because it provides fine adjustments. Alternatively, however, the light amount adjustment stage based on a ball screw may be used.

Further, the same effect is obtained when the intensity of light emitted from the light source is changed by changing the amount of electrical current supplied to the light source.

LEDs have a large directivity angle. It is therefore preferred that a short-focus, high-NA lens be used as the optical fiber condensing lens 12a. In such an instance, increased light use efficiency is achieved when an aspheric lens is combined with an optical fiber condensing lens 12c as shown in FIG. 13(c) and light is condensed at an optical fiber end face after collimation.

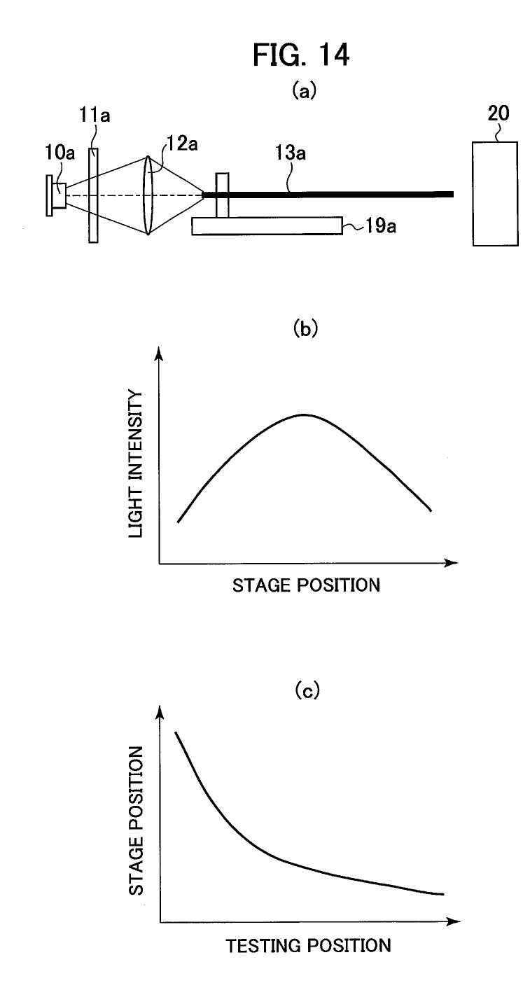

FIGS. 14(a) to 14(c) are schematic diagrams illustrating a light amount adjustment evaluation device according to the seventh embodiment.

In advance, the intensity of light that is emitted from the illumination LED light source 10a and passed through the diffuser plate 11a, the optical fiber condensing lens 12a, and the optical fiber 13a is measured with a measuring device such as a power measuring device 20, and the evaluation device shown in FIG. 14(a) is used to determine the relationship between the intensity of light and the position of the light amount adjustment stages 19a, 19b, which is shown, for instance, in FIG. 14(b).

Next, the surface inspection apparatus according to the seventh embodiment is used to determine a desired light intensity relative to the sample position from the position of the optical fiber 12a (FIG. 14(c)).

FIG. 14(c) shows the relationship between the position of the slide drive unit 113 for moving the sample stage in the radial direction of the sample 100 (that is, the position of the illumination spot formed on the sample 100) (vertical axis) and the position of the light amount adjustment stages 19a, 19b (horizontal axis).

In other words, when the relationship depicted in FIGS. 14(b) and 14(c) is obtained, it is possible to determine the amount by which the light amount adjustment stages 19a, 19b need to be moved to obtain a desired light intensity at a certain testing position.

In the seventh embodiment, tabulated values derived from FIG. 14(c) are stored and used during testing to automatically adjust the amount of light in accordance with the sample position.

That is to say, the seventh embodiment changes the relative distance to the illumination LED light sources and optical fibers 13 in accordance with the operation of a transport system such as the position of the stage to change the intensity of light incident on the sample.

In other words, the seventh embodiment can exercise control to change the intensity of light incident on the sample by changing the relative distance to the illumination LED light sources and optical fibers 13 for inner to outer portions of the sample 100.

Further, the multi-pixel sensor 104 in the surface inspection apparatus shown in FIG. 12 may be used before testing to actually measure the light intensity-to-stage position relationship shown in FIG. 14(b) instead of using the light amount adjustment evaluation device for determining the relationship shown in FIG. 14(b).

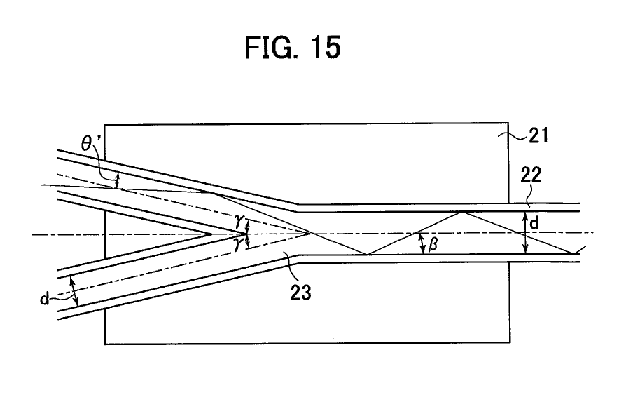

FIG. 15 is an enlarged view of an optical fiber multiplexer 14.

LEDs are a surface-emitting device and greater in directivity angle than lasers and LDs. Therefore, the LEDs are lower in brightness than the lasers and LDs.

As such being the case, it is conceivable that the multiplexer shown in FIG. 15 can be used for coupling purposes. However, if an optical fiber coupling angle γ and a maximum angle θ of light incidence on an optical fiber are not properly set, most of the light is absorbed by a clad portion immediately after an optical fiber coupling.

If the angle at which the optical fiber is coupled is γ when the light whose propagation angle within the optical fiber before optical fiber coupling is θ′, as shown in FIG. 15, propagates while being totally reflected, the propagation angle β within the optical fiber after coupling can be expressed by Equation 1.

β=γ+θ′ Equation 1

However, it is assumed that input and output core diameters are the same.

A mode having a propagation angle of β can provide total reflection within the optical fiber core when the propagation angle β is smaller than a maximum light receiving angle. Therefore, the propagation angle β can be expressed by Equation 2.

β≦sin⁻¹(n₁\sqrt{2Δ}) Equation 2

A relative refractive index difference Δ can be expressed by Equation 3.

$$Δ = \frac{{n}_{1}^{2} - {n}_{2}^{2}}{2 {n}_{1}^{2}} \qquad Equation 3$$

Here, the refractive index of an optical fiber core portion 23 is n₁ and the refractive index of a clad portion 22 is n₂.

An angle θ at which light emitted from an airborne light source is incident on the optical fiber can be expressed by Equation 4.

$$θ = \frac{1}{{n}_{1}} {sin}^{- 1} {θ}^{′} \qquad Equation 4$$

Consequently, the relationship concerning the angle for achieving optical multiplexing without a loss can be expressed by Equation 5.

When the angle θ is set so as to satisfy Equation 5, it is possible to avoid the absorption of light at the earlier-mentioned portion immediately after the coupling.

$$θ \leq \frac{1}{{n}_{1}} {sin}^{- 1} ( sin ( {n}_{1} \sqrt{2 Δ} - γ ) ) \qquad Equation 5$$

To avoid bending loss, it is preferred that the circumference of the optical fiber coupling be secured by an optical fiber retainer 21 made, for instance, of resin.

Although one multiplexer is shown in FIG. 12, the number of multiplexers is not particularly limited as far as Equation 5 is satisfied.

It should also be noted that Equations 1 to 5 can be established no matter whether single-mode optical fibers or multi-mode optical fibers are used. In other words, the single-mode optical fibers and the multi-mode optical fibers can be both used in the seventh embodiment.

The seventh embodiment not only provides the same excellent advantages as the first embodiment, but also prevents the sample from being damaged while providing a uniform signal-to-noise ratio.

Although the seventh embodiment uses two illumination LED light sources 10a, 10b, the number of illumination LED light sources may be limited to one.

Further, the two illumination LED light sources 10a, 10b may differ in intensity.

Furthermore, the two illumination LED light sources 10a, 10b may differ in wavelength. If the two illumination LED light sources 10a, 10b differ in wavelength, they should be combined with an optical system that reduces the influence of chromatic aberration as described in connection with the fifth embodiment.

Using the above-mentioned optical system makes it possible to provide the same excellent advantages as the first embodiment, prevent the sample from being damaged while providing a uniform signal-to-noise ratio, and avert the influence of chromatic aberration. As a result, wavelength-dependent defects can also be efficiently detected.

Although the present invention has been described with reference to specific embodiments thereof, it is not intended that the present invention be limited to such embodiments.

Further, the foregoing embodiments have been described on the assumption that semiconductor wafers are to be tested. However, items to be tested are not limited to semiconductor wafers. The present invention can also be applied to the testing of substrates such as hard disk substrates and liquid-crystal substrates.

### DESCRIPTION OF REFERENCE NUMERALS

10a, 10b . . . Illumination LED light source
11a, 11b . . . Diffuser plate
12a, 12b, 12c . . . Optical fiber condensing lens
13a, 13b . . . Optical fiber
14 . . . Coupler
15, 1101 . . . Condensing lens
16 . . . Polarizer
17 . . . Coupler
18, 801, 1001a, 1001b . . . Multi-core optical fiber
19a, 19b . . . Light amount adjustment stage
20 . . . Power measuring device
21 . . . Optical fiber retainer
22 . . . Optical fiber clad portion
23 . . . Optical fiber core portion
100 . . . Sample
101 . . . Sample stage
102 . . . Stage drive unit
103 . . . Illumination light source
104, 104a, 104b, 104c . . . Multi-pixel sensor
105 . . . Signal processing unit
106 . . . Overall control unit
107 . . . Mechanical control unit
108 . . . Information display unit
109 . . . Input operation unit
110, 407 . . . Storage unit
111 . . . Rotary drive unit
112 . . . Vertical drive unit
113 . . . Slide drive unit
116 . . . Detection optical system
201, 202, 501 . . . Illumination light
203 . . . First detection optical system
204 . . . Second detection optical system
301 . . . First imaging optical system
302 . . . Second imaging optical system
303 . . . Diffraction grating
401, 403, 406 . . . Amplifier
402 . . . Band-pass filter
404a, 404b . . . Analog-to-digital converter
405 . . . Low-pass filter
502 . . . Foreign matter
601 . . . Pixels of multi-pixel sensor at illumination spot position
701 . . . Image intensifier
702 . . . Photoelectric conversion surface
703 . . . MCP
704 . . . Fluorescent plate
705 . . . Micro-array lens
706 . . . Electrons derived from photoelectric conversion of scattered light
802 . . . Optical fiber coupling
803 . . . Multi-core optical fiber trailing end
804 . . . Cross section of multi-core optical fiber leading end
805 . . . Core
806 . . . Cross section of multi-core optical fiber trailing end
807 . . . Parallel light lens
808 . . . Micro lens
1002 . . . Optical fiber trailing end
1003 . . . Optical fiber cores of 1001a
1004 . . . Optical fiber cores of 1001b
1005 . . . Concave mirror
1006 . . . Mirror
1102 . . . Light selection iris
1103 . . . Light condensing reflection mirror

1. An inspection apparatus that checks for a defect in a substrate, comprising:
a radiation optical system; and
a detection optical system;
wherein the radiation optical system includes
at least one LED light source, and
a waveguide for guiding light emitted from the LED light source.

2. The inspection apparatus according to claim 1,
wherein the radiation optical system includes an optical device that is disposed between the LED light source and the waveguide to diffuse the light emitted from the LED light source.

3. The inspection apparatus according to claim 1,
wherein the waveguide is an optical fiber or an iris.

4. The inspection apparatus according to claim 1,
wherein the waveguide is a multi-mode single-core optical fiber.

5. The inspection apparatus according to claim 1,
wherein the waveguide is a multi-core optical fiber.

6. The inspection apparatus according to claim 5,
wherein cores are linearly disposed at a substrate side end of the multi-core optical fiber.

7. The inspection apparatus according to claim 1, further comprising:
a first LED light source having a first wavelength; and
a second LED light source having a second wavelength.

8. The inspection apparatus according to claim 7,
wherein the radiation optical system includes a reflection optical system that is disposed between the waveguide and the substrate.

9. The inspection apparatus according to claim 7, further comprising:
a first multi-core optical fiber for guiding first light from the first LED light source; and
a second multi-core optical fiber for guiding second light from the second LED light source;
wherein cores of the first multi-core optical fiber and cores of the second multi-core optical fiber are alternately disposed at the substrate side end.

10. The inspection apparatus according to claim 7, further comprising:
a first multi-core optical fiber for guiding first light from the first LED light source; and
a second multi-core optical fiber for guiding second light from the second LED light source;
wherein cores of the first multi-core optical fiber and cores of the second multi-core optical fiber for guiding the second light from the second LED light source are randomly disposed at the substrate side end.

11. The inspection apparatus according to claim 1,
wherein the radiation optical system includes a cylindrical lens that condenses light transmitted through the waveguide.

12. The inspection apparatus according to claim 1,
wherein the radiation optical system includes an optical device that adjusts the polarization of light transmitted through the waveguide.

13. The inspection apparatus according to claim 1, comprising:
a detection optical system for detecting light from the substrate;
wherein the detection optical system is an imaging optical system and provided with a sensor having a plurality of pixels.

14. The inspection apparatus according to claim 13,
wherein the detection optical system includes an amplification device that amplifies the light from the substrate; and
wherein the sensor detects the light amplified by the amplification device.

15. The inspection apparatus according to claim 14,
wherein the detection optical system includes a transfer unit that transfers the amplification device.

16. The inspection apparatus according to claim 14,
wherein the detection optical system includes an optical device that provides spatial division between the sensor and the amplification device.

17. An inspection method comprising the steps of:
irradiating a substrate with light;
detecting the light from the substrate; and
checking for a defect in the substrate;
wherein light emitted from at least one LED light source is averaged and made incident on the substrate to test the substrate.

18. The inspection method according to claim 17,
wherein the averaged light is linearly condensed and made incident on the substrate.

19. The inspection method according to claim 17,
wherein the polarization of the averaged light is controlled.

20. The inspection method according to claim 17,
wherein the averaged light has a first wavelength and a second wavelength.

21. The inspection method according to claim 17, further comprising the steps of:
amplifying the light from the substrate by using an amplification device;
imaging the amplified light; and
detecting the imaged light in a plurality of regions.

22. The inspection method according to claim 21, further comprising the step of:
varying the region on which the light from the substrate is incident on the amplification device.

23. The inspection method according to claim 21, further comprising the step of:
spatially dividing and imaging the amplified light.
